(19) United States
(12) Patent Application Publication
(10) Pub. No.: US 2013/0027729 A1
(43) Pub. Date: Jan. 31, 2013

(54) IMAGE FORMING APPARATUS, METHOD FOR CONTROLLING, AND STORAGE MEDIUM

(71) Applicant: Yuka Kamiya, Machida-shi (JP)

(72) Inventor: Yuka Kamiya, Machida-shi (JP)

(73) Assignee: CANON KABUSHIKI KAISHA, Tokyo (JP)

(21) Appl. No.: 13/558,171

(22) Filed: Jul. 25, 2012

(30) Foreign Application Priority Data
Jul. 29, 2011 (JP) 2011-167075

(51) Int. Cl. G06K 15/02

(52) U.S. Cl. 358/1.13

(57) ABSTRACT

A method includes acquiring script information from a first storage unit storing the script information including identification information capable of identifying processing, user information of a user who can use a function by the processing, and user information of a proxy who can use the functions as a substitute, identifying script information specified through a user operation out of the script information acquired by the acquisition, determining whether user information of a login user is included in the script information, extracting, when the user information is determined to be included therein, authority information associated with the user information of the user included in the script information from a second storage unit storing authority information indicating authority to use the function and the user information in an associated way, and executing the script information according to the authority included in the authority information.

### BACKGROUND OF THE INVENTION

1. Field of the Invention

The present invention relates to an image forming apparatus, a method for controlling, and a storage medium.

2. Description of the Related Art

With a conventional multifunction peripheral (MFP), a technique has been proposed to store settings of processing related to various functions as scripts and achieve target processing simply by specifying a target script without inputting complicated settings from an operation panel of the MFP. If a proxy is specified for the script, the proxy (a user different from a script creator) can execute and edit the script.

However, under an authority management server which manages the execution authority and editing authority for scripts, the proxy can perform substitutional operations within the scope of authority given to the proxy. Japanese Patent Application Laid-Open No. 2002-109278 discusses a substitution request system in which a server manages information about proxies' capability of substitution and, when implementing a predetermined operation, a proxy is selected based on the capability of substitution.

With the conventional technique, however, the proxy cannot perform operations exceeding proxy's capability. Specifically, if a client of substitution (for example, a user who can use function related to an operation of an MFP) has higher authority than the proxy, the client needs to specify operations taking the proxy's capability into consideration. In this case, however, it is difficult for the client to recognize the proxy's capability in detail. Further, although a method for giving the proxy equivalent authority to client's authority is assumed, this method is not suitable when the authority is to be limited in regular operations other than substitutional operations.

### SUMMARY OF THE INVENTION

The present invention is directed to controlling substitution of a user who can use a function of an image forming apparatus in more suitable way.

According to an aspect of the present invention, an image forming apparatus capable of communicating with a first storage unit and a second storage unit and performing processing to provide a function includes: an acquisition unit configured to acquire script information from the first storage unit storing the script information including identification information capable of identifying processing, user information of a user who can use the functions by the processing, and user information of a proxy who can use the function as a substitute; an identification unit configured to identify script information specified through a user operation out of the script information acquired by the acquisition unit; and an execution unit configured to determine whether user information of a login user is included in the script information, to extract, when the user information is determined to be included therein, authority information associated with the user information of the user included in the script information from the second storage unit storing authority information indicating authority to use the function and the user information in an associated way, and to execute the script information according to the authority included in the authority information.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example configuration of a system.

FIG. 2 illustrates an example hardware configuration of an MFP.

FIG. 3 illustrates an example data structure of a script.

FIG. 4 is an example flowchart illustrating processing for executing a script.

FIG. 5 is an example flowchart illustrating processing for editing a script.

FIG. 6 is an example flowchart illustrating processing for duplicating a script.

FIG. 7 illustrates an example script.

### DESCRIPTION OF THE EMBODIMENTS

Various exemplary embodiments, features, and aspects of the invention will be described in detail below with reference to the drawings.

The exemplary embodiments do not limit the present invention, and not all configurations described therein are necessary to solve problems of the present invention.

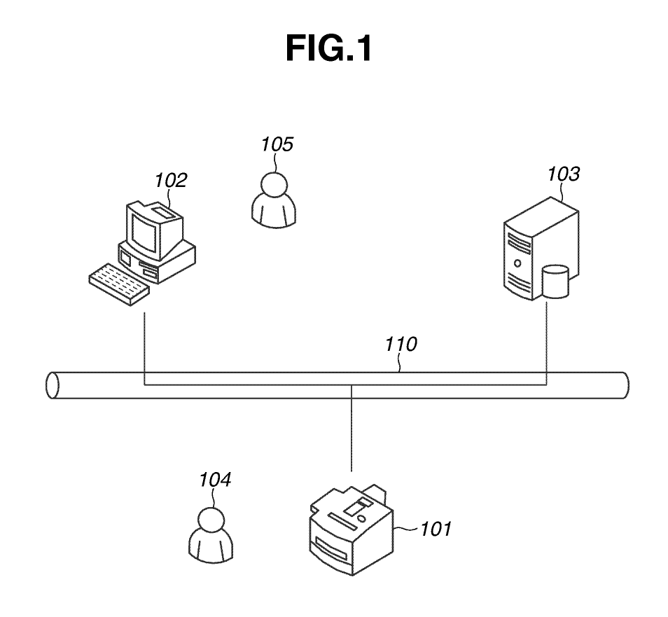

The present exemplary embodiment relates to a technique for storing scripts (script information) in a storage device (example of first storage unit) to perform processing related to functions of an image forming apparatus, and calling up a script from the storage device in response to a user instruction to execute the script. FIG. 1 illustrates an example configuration of a system according to the present exemplary embodiment. The present system includes an MFP 101, a client machine 102, and an authority management server 103 which are connected via a local area network (LAN) 110 to each other so that they are capable of communicating with each other.

The MFP 101 (example of image forming apparatus (computer)) is connected to the LAN 110 together with the client machine 102 and the authority management server 103. The client machine 102 (example of information processing apparatus (computer)) communicates with the authority management server 103 via the LAN 110. Operations of the authority management server 103 are performed by the client machine 102.

The authority management server 103 (example of information processing apparatus (computer)) communicates with the MFP 101 and the authority management server 103 via the LAN 110. The authority management server 103 includes a mass storage (example of second storage unit) for storing execution authority information for each user. The execution authority information (example of authority information) indicates user's authority for performing processing of respective functions of the image forming apparatus, and is provided for each user (user information enabling user identification). For example, the execution authority information is provided for each user. The present information includes respective functions of the image forming apparatus, such as reading a document, storing read data in a box, and printing, transmitting, and copying read data and box data (documents, etc.). When such execution authority information for each user is requested by the MFP 101, necessary pieces of information are extracted from the authority management server 103 and then transmitted to the MFP 101.

In the present exemplary embodiment, the execution authority information is provided for setting values (example of setting information) used for processing of each function on a user basis. However, the system configuration is not limited thereto. Specifically, the system is not necessarily configured with a mixed configuration where the authority information and user information are stored in the second storage unit in an associated way, and on a configuration where the authority information, user information, and setting information are stored in the second storage unit in an associated way. For example, the system may be simply configured with a configuration where the authority information and user information are stored in the second storage unit in an associated way. Also, the system may be simply configured with a configuration where the authority information, user information, and setting information are stored in the second storage unit in an associated way.

Although, in the present exemplary embodiment, the execution authority information is stored in the authority management server 103, and a user refers to the execution authority information from the MFP 101 via the LAN 110, the system configuration is not limited thereto. For example, the execution authority information may be stored in a storage device included in the MFP 101, and a user may refer to it as required. Although, in the present exemplary embodiment, the execution authority information is individually provided for each user, the configuration is not limited thereto. For example, the execution authority information common to all users may be provided, or the execution authority information for each group including one or a plurality of users may be provided. Referring to FIG. 1, the MFP 101 is operated by a user 104 and the client machine 102 is operated by a user 105. Although, in the present exemplary embodiment, a user operates the authority management server 103 from the client machine 102, the configuration is not limited thereto. For example, the authority management server 103 may include an own user interface, and the user may directly operate the authority management server 103.

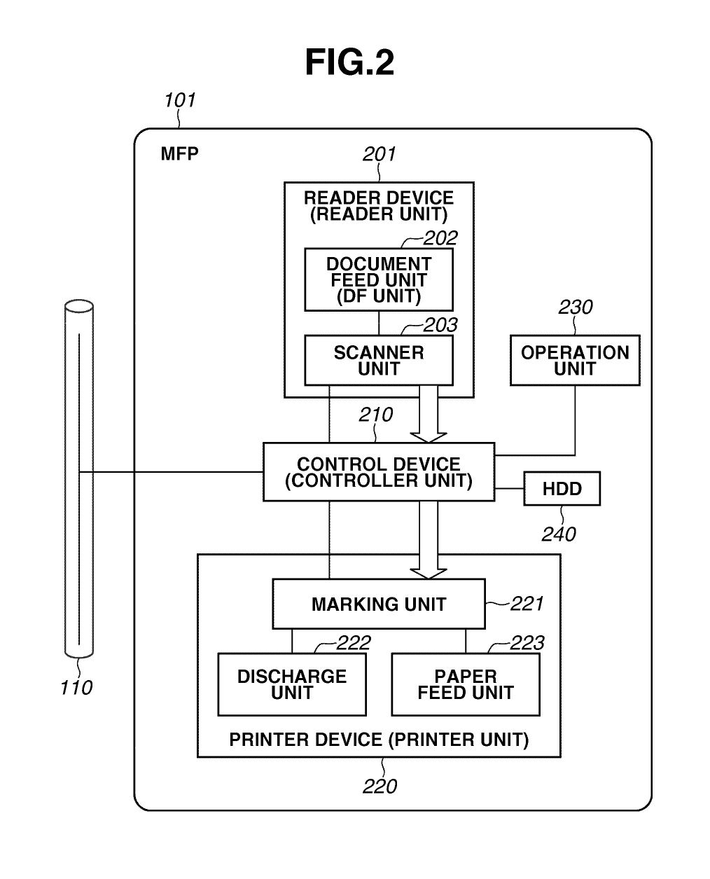

FIG. 2 illustrates an example hardware configuration of the MFP 101. A reader device 201 optically reads a document to convert the read document to image data. The reader device 201 includes a scanner unit 203 having a function of reading a document, and a document feed unit 202 having a function of conveying the document. Depending on the hardware configuration, the reader device 201 may not include the document feed unit 202. In this case, a document is placed on a platen glass (alternatively referred to as pressing plate) and read by a sensor. A printer device 220 conveys a paper sheet (example of recording medium), prints image data as a visible image on the sheet, and discharges the sheet to the outside of the image forming apparatus. The printer device 220 includes a paper feed unit 223 including a plurality of types of paper cassettes, a marking unit 221 for transferring and fixing image data onto the sheet, and a discharge unit 222 for sorting, stapling, and discharging printed sheets.

A control device 210 controls the entire MFP 101 and includes a central processing unit (CPU), a read-only memory (ROM), a random access memory (RAM), etc. (not illustrated). When the CPU performs processing according to procedures of a program stored in the RAM, functions of the MFP 101 and processing in flowcharts (described below) are achieved. Functions of the MFP 101 and processing in flowcharts (described below) may be partially or entirely configured by dedicated hardware. The control device 210 is electrically connected with the reader device 201 and the printer device 220, and connected with the LAN 110. The control device 210 further controls the reader device 201 to read an image data of a document, and then controls the printer device 220 to output the image data onto a sheet, thus providing the copy function. The control device 210 further converts the image data (read from the reader device 201) into code data and then transmits it to a host computer via the LAN 110, thus providing the network scanner function.

The control device 210 further registers the image data (read from the reader device 201) in a box (storage service) provided in a hard disk drive (HDD) 240, thus providing the box scanning function. The control device 210 outputs the image data registered in the box to the printer device 220, thus providing the box print function. The control device 210 further converts code data (received from the host computer via the LAN 110) into image data and then outputs it to the printer device 220, thus providing the printer function. An operation unit 230 includes a liquid crystal display (LCD) unit, a touch panel input device (touch panel) attached to the LCD unit, and a plurality of hard keys to provide a user interface (UI) for receiving variety of user operations. Signals input from the touch panel and the hard key are transferred to the control device 210. The LCD unit is an example of a display unit to display data transmitted from the control device 210.

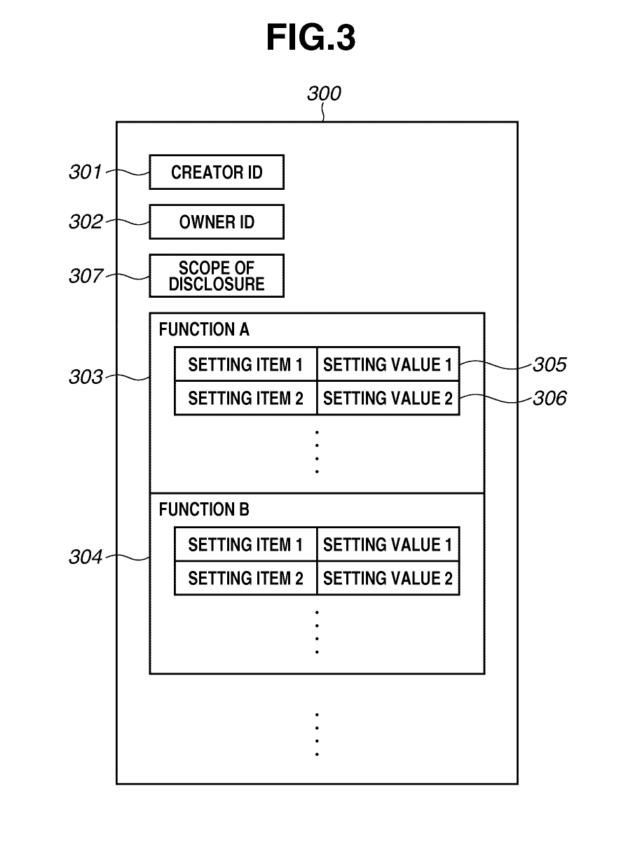

FIG. 3 illustrates an example data structure of a script 300. The script 300 will be described below on the premise that it is stored in the HDD 240. The script 300 includes a creator identifier (ID) 301 (example of user information) for identifying a user who originally created the script 300, and an owner ID 302 (example of user information) for identifying a user who owns the script 300. The script 300 further includes information for identifying processing related to functions such as functions A and B (example of identification information for identifying processing). The script 300 further includes one or a plurality of settings (a setting 303, a setting 304, etc.) used for processing related to one or a plurality of functions. For example, the setting 303 includes a plurality of setting items used for processing of the function A, and a plurality of setting values (a setting value 1 (305), a setting value 2 (306), etc.) corresponding to respective plurality of setting items. The script 300 further includes a scope of disclosure 307. In the present exemplary embodiment, a script creator refers to a user who creates a script for delegating operations (a user who can use functions related to operations by using the MFP 101). A script owner refers to a user who is assumed to execute the script (a proxy who can perform operations as a substitute). The owner ID 302 includes at least one user ID of the script owner. The user ID of the script owner is specified by the script creator when the script creator creates a script.

When the MFP 101 is operating in collaboration with an authentication application of the present system, the MFP 101 can basically execute the script when a user having the creator ID or owner ID specified in the script logs into the system. However, in the present exemplary embodiment, “individual” or “shared” can be specified as the scope of disclosure 307. When “shared” is specified, even a user who does not correspond to the creator ID and owner ID can execute and edit the script as long as the user has the authority. When “individual” is specified as the scope of disclosure 307, only the script creator or owner can execute and edit the script as described above. The plurality of functions refers to the scanning function, print function, transmit function, etc. of the MFP 101. As described above, a script includes parameters required for performing processing of each function as a setting value of each setting item.

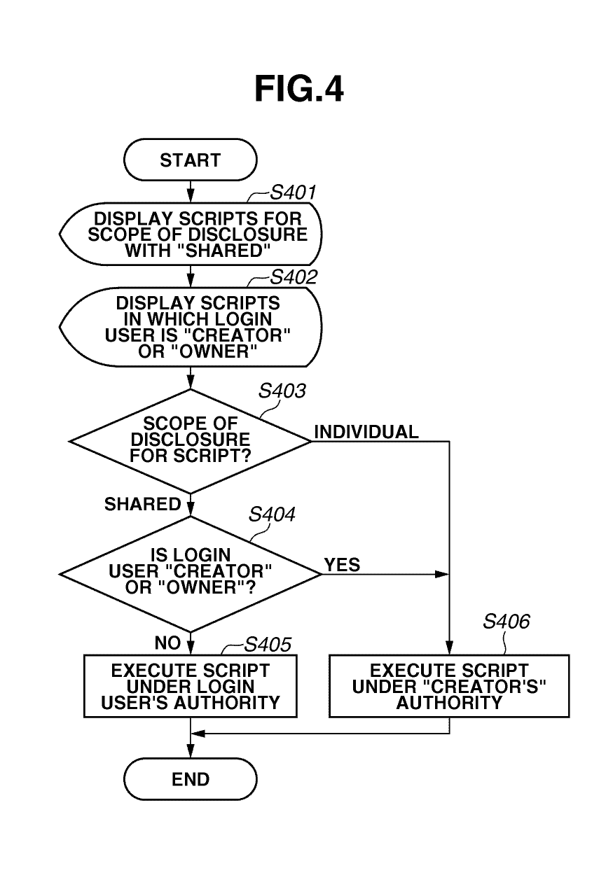

FIG. 4 is an example flowchart illustrating processing (processing at the time of execution) when a script is executed. In step S401, when the user logs into the MFP 101, the control device 210 acquires scripts for the scope of disclosure 307 with “shared” from the HDD 240, and then displays the acquired scripts on the operation unit 230. In step S402, from among the remaining scripts (scripts for the scope of disclosure 307 with “individual”), the control device 210 acquires from the HDD 240 scripts in which the user who logged in (login user) is the creator or owner, and then displays the acquired scripts on the operation unit 230. The scripts displayed on the operation unit 230 in step S401 and the scripts displayed on the operation unit 230 in step S402 may be displayed on one screen in a distinguishable way or displayed on different screens in a switchable way. Specifically, the display form is not limited to a specific one.

The login user operates the touch panel to select a script from among the displayed scripts to instruct the execution of the script. In step S403, the control device 210 determines the scope of disclosure 307 of the script to be executed. When the control device 210 determines that the scope of disclosure 307 is “individual” (INDIVIDUAL in step S403), the processing proceeds to step S406. When the control device 210 determines that the scope of disclosure 307 is “shared” (SHARED in step S403), the processing proceeds to step S404. The processing proceeds to step S406 because the user ID of the login user is provided as the user ID of the script creator or owner. Even if the login user is not the script creator, it is assumed that the script creator specifies the login user as a script owner who executes the script. Specifically, the control device 210 determines that the script creator has transferred authority to the login user.

Otherwise, the processing proceeds to step S404 because a user other than the script creator or owner has logged in since the scope of disclosure 307 is “shared.” In step S404, therefore, the control device 210 determines whether the login user is either of the script creator or the owner. When the control device 210 determines that the login user is not the script creator or owner, i.e., the user IDs of the login user and the script creator or owner are not identical (NO in step S404), the processing proceeds to step S405. When the control device 210 determines that the login user is the script creator or owner (YES in step S404), the processing proceeds to step S406. When the processing proceeds to step S406, similar to the case where the scope of disclosure 307 is “individual” in step S403, the control device 210 determines that the script creator has transferred authority to the login user even if the login user is not the script creator.

In step S405, the control device 210 extracts the execution authority information of the login user from the authority management server 103 by using the user ID of the login user as a key, and then executes the script within the scope of the login user's authority. The present processing is performed because the login user is neither the script creator nor the script owner to whom the script creator transferred the authority. If the script includes any function or setting value beyond the scope of the login user's authority, the execution of the script results in an abnormal end. In step S406, the control device 210 extracts the execution authority information of the script creator from the authority management server 103 by using the user ID of the script creator as a key, and then executes the script within the scope of the script creator's authority. Even if the script includes any function or setting value beyond the scope of the login user's authority, the present processing enables executing the script without error. If the login user is the script creator, the execution authority information of the script creator is extracted from the authority management server 103 and therefore the script is normally executed.

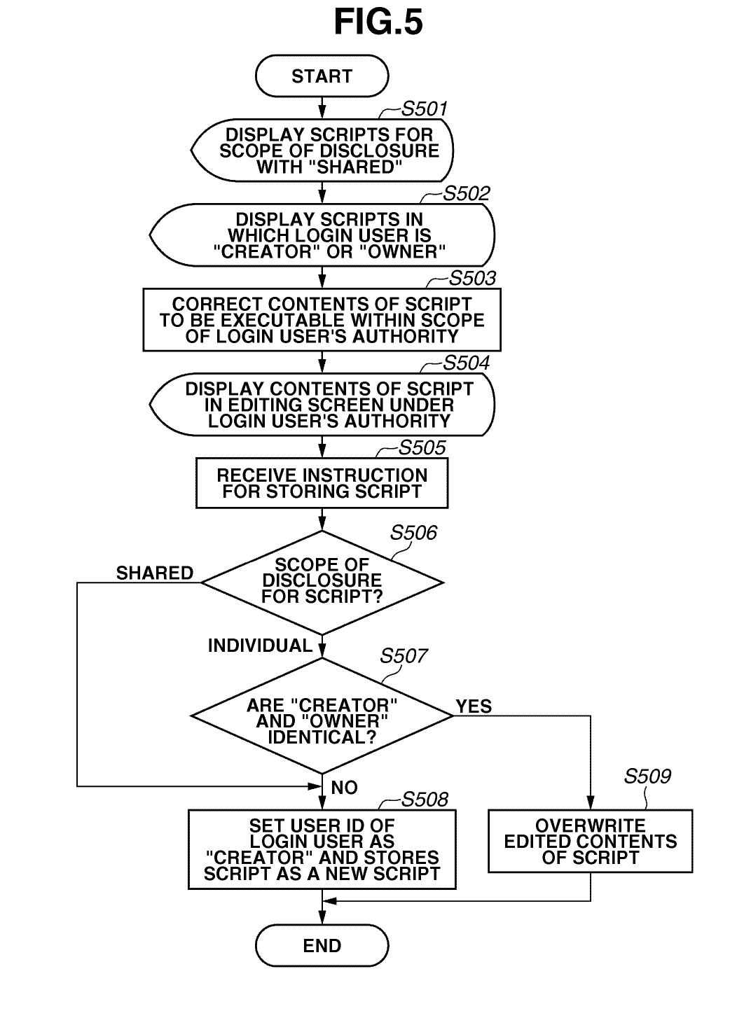

FIG. 5 is an example flowchart illustrating processing for editing a script (processing at the time of editing). Steps S501 and S502 display scripts on the operation unit 230 when the user logs in, similar to steps S401 and S402 when executing a script, and duplicated descriptions will be omitted. When the user operates the touch panel to specify a script to be edited, in step S503, the control device 210 extracts the execution authority information of the login user from the authority management server 103, and then corrects the contents of the script within the scope of the login user's authority. Specifically, when the original script includes any function or setting value of setting items beyond the scope of the login user's authority, the control device 210 deletes the relevant function or setting value or changes the function or setting value to another executable within the login user's authority. The following describes a case where the control device 210 extracts a plurality of execution authority information corresponding to a plurality of setting values of one setting item, and, based on the execution authority information of the setting values, determines that the authority is not given to the execution with the setting values specified in the script. In this case, the control device 210 identifies setting values to which authority is given based on the extracted execution authority information, and then changes the setting values specified in the script based on the identified setting values. Setting values to be used out of the identified setting values are determined to employ a suitable configuration.

In step S504, the control device 210 displays the contents of the corrected script on the operation unit 230. Then, the login user operates the touch panel to end editing the script. In step S505, the control device 210 receives an instruction for storing the script. In step S506, the control device 210 determines the scope of disclosure 307 of the original script. When the control device 210 determines that the of disclosure scope 307 is “shared” (SHARED in step S506), the processing proceeds to step S508. When the control device 210 determines that the scope of disclosure 307 is “individual” (INDIVIDUAL in step S506), the processing proceeds to step S507. In step S507, the control device 210 determines whether the script creator and the script owner of the original script are identical (both user IDs are matched). When the control device 210 determines that the script creator and the script owner are identical (YES in step S507), the processing proceeds to step S509. When the control device 210 determines that the script creator and the script owner are not identical (NO in step S507), the processing proceeds to step S508.

In step S508, the control device 210 records the user ID of the login user as a creator of the edited script, and stores (adds) the edited script in the HDD 240 as a new one. The above-described processing enables preventing the original script (offered for the purpose of transferring authority) from being abused through subsequent editing by the login user (preventing functions and setting values from being used beyond the scope of the given authority). In step S509, the control device 210 overwrites the contents of edition onto the original script. If the script creator or owner has not yet logged in, scripts are not displayed in the step S502. Specifically, when the control device 210 determines that the script creator and the script owner are identical in step S507, the login user who edits the script is also the script creator and script owner of the original script. Therefore, the login user can overwrite the script through user operation without problem. When the control device 210 determines that the script creator and the script owner are not identical in step S507, the processing proceeds to step S508. In step S508, the control device 210 updates the creator ID with the user ID of the login user and then stores the script as a new one.

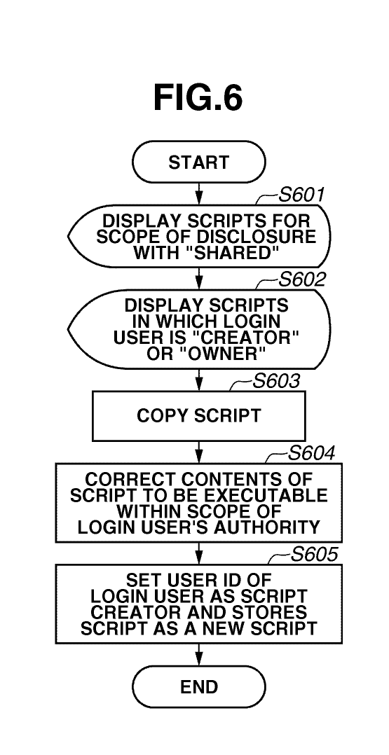

FIG. 6 is an example flowchart illustrating processing for duplicating a script (processing at the time of duplication). Steps S601 and S602 display scripts on the operation unit 230 when the user logs in, similar to steps S401 and S402 when executing a script, and duplicated descriptions will be omitted. When the user operates the touch panel to specify a script to be duplicated, in step S603, the control device 210 makes a copy of the specified script (duplicates the specified script).

In step S604, the control device 210 extracts the execution authority information of the login user from the authority management server 103, and corrects the contents of the script within the scope of the login user's authority. Specifically, when the original script includes any function or setting value of setting items beyond the scope of the login user's authority, the control device 210 deletes the relevant function or setting value or changes the function or setting value to another executable within the login user's authority. Details of processing are similar to step S503, and duplicated descriptions will be omitted. In step S605, the control device 210 records the user ID of the login user as the creator of the script corrected in step S604, and stores (adds) the script in the HDD 240 as a new one.

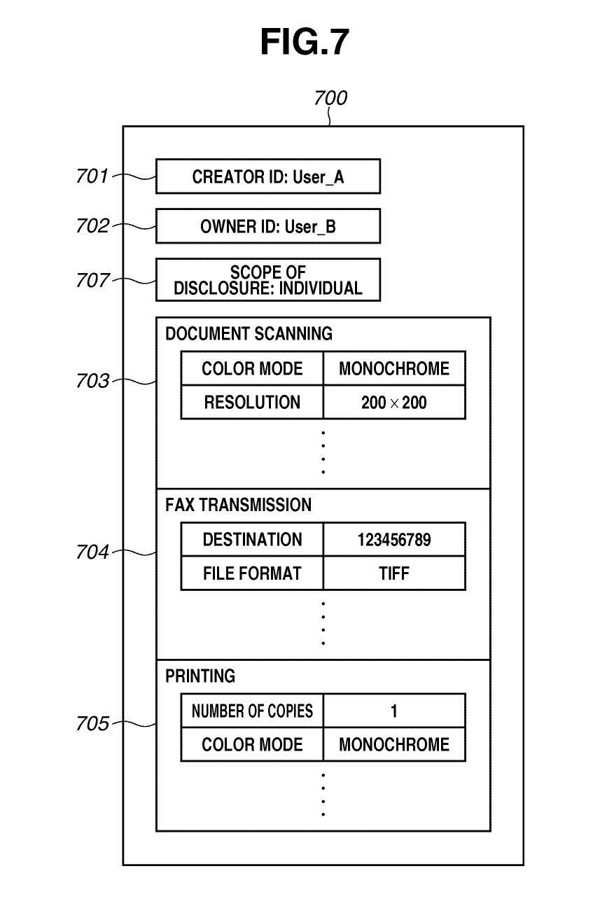

A use case will be described below. For example, a user A (managerial-level staff) requests a user B (general staff) for substitution of facsimile (FAX) transmission operation. Further, the following case is assumed: the user A makes a copy of the document to be transmitted to confirm FAX transmission and manage a history of FAX transmission, and the user A keeps the document and the user B keeps a print product. However, it is assumed that although the user A has the authority of FAX transmission, the user B is not given the authority of FAX transmission. FIG. 7 illustrates an example script (script 700) including specific settings for implementing the above-described use case based on the data structure of the script illustrated in FIG. 3. Processing for executing, editing, and duplicating a script will be described below with reference to the script 700.

First, the user A creates for the user B the script 700 for scanning a document to generate an image, transmitting the generated image by FAX, and printing the image. In the present exemplary embodiment, the method for creating a script is not limited to a particular one. For example, a script may be created via an operation screen of the operation unit 230 and then stored in the HDD 240 of the MFP 101. Further, a script may be created by using a script creation application installed in the client machine 102 or another client machine (not illustrated) connected to the LAN 110 and uploaded to the MFP 101. Further, a script created by a client machine may be stored in a server machine (not illustrated) different from the MFP 101, and, when operating the script, downloaded from the server machine to the MFP 101.

Since a creator ID 701 is User_A, an owner ID 702 is User_B, and the scope of disclosure 707 is “individual”, it is understood that the script 700 is created by the user A to request the user B for operations. The requested operations include scanning a document to generate an image, transmitting the generated image by FAX, and printing the image. Processing performed when the user B executes the script 700 will be described below with reference to FIG. 4. When the user B logs into the MFP 101, the script 700 is displayed on the operation unit 230 based on the condition in step S402, i.e., User_B (user ID of the user B) is included in the script 700.

When the user B operates the touch panel to issue an instruction for executing the script 700, in step S403, the control device 210 determines the scope of disclosure 707 of the script 700. Since the scope of disclosure 707 of the script 700 is “individual” (INDIVIDUAL in step S403), the processing proceeds to step S406. In step S406, the control device 210 executes the script 700 under the authority of the creator ID 701. Since the user B originally instructs the execution of a script, the MFP 101 cannot perform processing of FAX transmission of the script 700. However, in the present exemplary embodiment, the control device 210 uses (checks) the authority of the user A who is the creator of the script 700, as described in step S406. Thus, even if the user who actually executes the script is the user B, FAX transmission is enabled and requested operations can be accomplished.

Processing performed when the user B edits the script 700 will be described below with reference to FIG. 5. When the user B logs into the MFP 101, the script 700 is displayed on the operation unit 230 based on the condition in step S502, i.e., User_B (user ID of the user B) is included in the script 700. When the user B operates the touch panel to issue an instruction for editing the script 700, in step S503, the control device 210 determines the authority of the user B (login user) and corrects the script 700. Specifically, since the user B does not have the authority for FAX transmission, the control device 210 deletes a setting value 704 related to FAX transmission in the script 700. More specifically, the control device 210 forcibly converts the script 700 into a script (including setting values 703 and 705) for scanning a document to generate an image and printing the generated image.

The user B operates the editing screen for the converted script displayed on the operation unit 230 to edit the script. In this case, when the user B attempts to input a setting value of setting items related to FAX transmission, a warning message is displayed. Alternatively, the user B may be not allowed to input a setting value related to FAX transmission by hiding setting items related to FAX transmission. When the user B operates the touch panel to complete editing the script and issue an instruction for storing the script, in step S506, the control device 210 determines the scope of disclosure 707. Since the scope of disclosure 707 is “individual”, in step S507, the control device 210 further determines whether the user ID of the script creator (creator ID 701) and the user ID of the script owner (owner ID 702) are identical. In the present exemplary embodiment, since the script creator is the user A and the script owner is the user B (the above-described two user IDs are not identical), in step S508, the control device 210 updates the user ID (User_A) of the user A (script creator), to the user ID (User_B) of the user B (login user), and stores the script.

Processing performed when the user B duplicates the script 700 will be described below with reference to FIG. 6. When the user B logs into the MFP 101, the script 700 is displayed on the operation unit 230 based on the condition in step S602, i.e., User_B (user ID of the user B) is included in the script 700. When the user B operates the touch panel to issue an instruction for duplicating the script 700, in step S604, the control device 210 determines the authority of the user B (login user) and corrects the script 700. Specifically, since the user B does not have the authority for FAX transmission, the control device 210 deletes a setting value 704 related to FAX transmission in the script 700. More specifically, the control device 210 forcibly converts the script 700 into a script (including setting values 703 and 705) for scanning a document to generate an image and printing the generated image. After script conversion, in step S605, the control device 210 updates the user ID (User_A) of the user A (script creator), to the user ID (User_B) of the user B (login user), and stores the script.

In the present exemplary embodiment, when a user C (third person) logs in, the script 700 is not displayed on the operation unit 230 based on the conditions in steps S401, S402, S501, S502, S601, and S602. However, the configuration is not limited thereto. For example, the script 700 is displayed on the operation unit 230 and, when the user C issues an instruction for executing, editing, or duplicating the script 700, an error message may be displayed to prevent the relevant operation. As described above, the attribute of the scope of disclosure of the script, the attribute of the script owner, the attribute of the script creator, and the attribute of the login user are checked. Therefore, even if each individual user has different authority, a proxy can execute a script under the authority of a user who requested substitution of operations. Thus, substitution of operations can be smoothly performed. Further, when the login user edits or duplicates a script, the user ID of the script creator is changed to the user ID of the login user, the contents of the script are corrected according to the login user's authority, and the corrected script is stored as a new one. Thus, the script can be prevented from being abused by the login user.

### Other Embodiments

Aspects of the present invention can also be realized by a computer of a system or apparatus (or devices such as a CPU, a micro processing unit (MPU), and/or the like) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., a non-transitory computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-167075 filed Jul. 29, 2011, which is hereby incorporated by reference herein in its entirety.

What is claimed is:

1. An image forming apparatus capable of communicating with a first storage unit and a second storage unit, and configured to perform processing to provide a function, the image forming apparatus comprising:
an acquisition unit configured to acquire script information from the first storage unit storing the script information including identification information capable of identifying processing, user information of a user who can use the function by the processing, and user information of a proxy who can use the function as a substitute;
an identification unit configured to identify script information specified through a user operation out of the script information acquired by the acquisition unit; and
an execution unit configured to determine whether user information of a login user is included in the script information, to extract, when the user information is determined to be included therein, authority information associated with the user information of the user included in the script information from the second storage unit storing authority information indicating authority to use the function and the user information in an associated way, and to execute the script information according to the authority included in the authority information.

2. The image forming apparatus according to claim 1, further comprising:
a control unit configured to control such that, the control unit determines, when a user operation for editing the script information identified by the identification unit is received, whether the user information of the user and the user information of the proxy included in the script information are identical, changes, when the two pieces of the user information are determined not to be identical, the user information of the user to the user information of the login user included in the script information, and adds the changed script information in the first storage unit.

3. The image forming apparatus according to claim 1, further comprising:
a control unit configured to control such that, the control unit duplicates, when a user operation for duplicating the script information identified by the identification unit is received, the script information, changes the user information of the user included in the duplicated script information to the user information of the login user, and adds the changed script information in the first storage unit.

4. A method for controlling an image forming apparatus capable of communicating with a first storage unit and a second storage unit and configured to perform processing to provide a function, the method comprising:
acquiring, by an acquisition unit, script information from the first storage unit storing the script information including identification information capable of identifying processing, user information of a user who can use the function by the processing, and user information of a proxy who can use the function as a substitute;
identifying, by an identification unit, script information specified through a user operation out of the script information acquired by the acquisition; and
determining, by an execution unit, whether user information of a login user is included in the script information, extracting, when the user information is determined to be included therein, authority information associated with the user information of the user included in the script information from the second storage unit storing authority information indicating authority to use the function and the user information in an associated way, and executing the script information according to the authority included in the authority information.

5. A non-transitory computer-readable storage medium storing a program for causing a computer capable of communicating with a first storage unit and a second storage unit and configured to perform processing to provide a function to perform as units comprising:
an acquisition unit configured to acquire script information from the first storage unit storing the script information including identification information capable of identifying processing, user information of a user who can use the functions by the processing, and user information of a proxy who can use the function as a substitute;
an identification unit configured to identify script information specified through a user operation out of the script information acquired by the acquisition unit; and
an execution unit configured to determine whether user information of a login user is included in the script information, to extract, when the user information is determined to be included therein, authority information associated with the user information of the user included in the script information from the second storage unit storing authority information indicating authority to use the function and the user information in an associated way, and to execute the script information according to the authority included in the authority information.
